(19) United States
(12) Patent Application Publication
(10) Pub. No.: US 2026/0109132 A1
(43) Pub. Date: Apr. 23, 2026

(54) FLEXIBLE ELECTRICAL INSULATING FABRIC WITH VERTICAL FEATURES

(71) Applicant: ZHONG QIANG YI TECHNOLOGY CO., LTD., TAICHUNG CITY (TW)

(72) Inventors: TZU-CHIANG KAO, TAICHUNG CITY (TW); YU-SHENG KAO, TAICHUNG CITY (TW)

(21) Appl. No.: 18/919,132

(22) Filed: Oct. 17, 2024

(51) Int. Cl. B32B 5/24; B32B 3/30; B32B 5/02; B32B 5/18

(52) U.S. Cl. CPC B32B 5/245; B32B 3/30; B32B 5/02; B32B 5/18; B32B 2262/02; B32B 2266/0214; B32B 2307/206; B32B 2307/538; B32B 2307/7376

(57) ABSTRACT

This invention discloses a series of tall vertically raised and deep depressed features on the surface of the fabric that extends the electrical current pathway and hence lower the electrical conductance of the fabric surface and the diminish the risk of electrocution via surface conduction paths.

### BACKGROUND OF THE INVENTION

### 1. Field of Invention

The present invention relates to the reduction of electrical conductance on the surface of a fabric by creating three-dimensional tall vertically raised and deep depressed features to increase the electrical current path length as compared to the length of the surface.

### 2. Description of Related Art

Fabrics used for protective clothing for electrical workers such as coveralls and shoes are made of electrically insulating materials. The degree of electrical insulation is so far solely dependent on the electrical conductivity of the bulk material used for the fabrics. However, electricity can also flow along the surface of the clothing where the electrical conductance tends to be higher than the bulk material. Therefore, electrocution can still occur when the electricity travels along the surface of the fabric and eventually contact the human skin.

### SUMMARY OF INVENTION

This invention discloses a series of tall vertically raised and deep depressed features on the surface of the fabric that extends the electrical current pathway and hence lower the electrical conductance of the fabric surface and the diminish the risk of electrocution via surface conduction paths.

### BRIEF DESCRIPTION OF DRAWINGS

FIG. 1 shows the cross-sectional view of the invention with hard surface layer, foam bulk layer, fiber bulk layer, a vertically raised feature and its sidewall, a vertically depressed feature and its sidewall.

FIG. 2 shows the extension of electrical current pathway with vertically raised and depressed features.

FIG. 3 shows vertically raised features on vertically raised features and vertically depressed features within vertically depressed features.

FIG. 4 shows vertically depressed features within vertically raised features and vice versa.

FIG. 5 shows vertically raised and depressed features with varying taper angles.

FIG. 6 shows the top view of a set of patterns and their combination can be used to form the vertically raised and depressed features.

FIG. 7(a) shows embodiment 1 (top view) and FIG. 7(b) shows embodiment 1 (three-dimensional view) consisting of linear ridge and trench array to lengthen surface electrical pathway.

FIG. 8(a) shows embodiment 2 (top view) and FIG. 8(b) shows embodiment 2 (three-dimensional view) consisting of hexagonal array to lengthen surface electrical pathway on the fabric surface.

FIG. 9 shows embodiment 3 (three-dimensional view) of vertical features consisting of circular depressions.

FIG. 10 shows embodiment 4 (three-dimensional view) of vertical features consisting of freeform ridges and trenches.

FIG. 11 shows embodiment 5 (three-dimensional view) of cascading vertical features.

FIG. 12 shows the stereoscope cross-sectional photograph of the hard surface layer, foam bulk layer, fiber bulk layer, a vertically depressed feature and its sidewall, and the radius of curvature of the edge on the vertically raised feature.

FIG. 13 shows the stereoscope cross-sectional photograph of a vertically raised feature within another vertically raised feature.

FIG. 14 shows the stereoscope cross-sectional photograph of a vertically depressed feature within another vertically raised feature.

FIG. 15 shows the photograph of a preferred embodiment that depicts a base layer with an array of circular depressions, and a cascade of vertical features.

### DETAILED DESCRIPTION OF PREFERRED EMBODIMENT

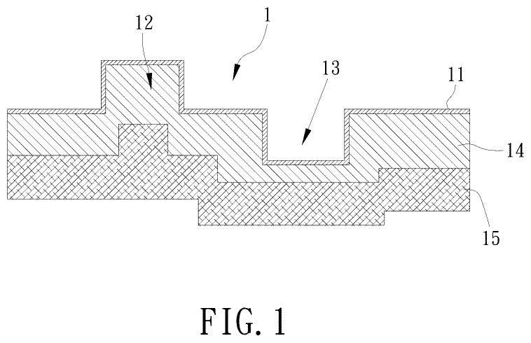

As shown in FIG. 1, the invention consists a hard, liquid-impermeable surface layer 11, a porous foam bulk layer 14 and a porous fiber bulk layer 15 with vertically raised feature 12 and depressed feature 13. The formation of the vertically raised feature 12 and vertical depressed feature 13 results in the partial compaction of the foam bulk layer 14. The hard surface layer 11 has a surface roughness from 10 nm to 0.1 mm with electrical conductivity of at least 1×10⁻¹² S/m. A soft foam bulk layer of air and elastomer matrix and a soft fiber bulk layer of air and elastomer matrix, Both the porous foam bulk layer 14 and porous fiber bulk layer 15 are each with a thickness of at least 0.5 mm and electrical conductivity of at least 1×10⁻¹² S/m. Both bulk layers (foam 14 and fiber 15) will have at least 10% elastomer by volume. The air and elastomer matrix consists of at least 10 % elastomer by volume. The elastomer can be, but is not limited to, thermoplastic elastomers, thermoplastic polyurethane, thermoplastic polyester elastomer, ethylene vinyl-acetate, polyester, and polyvinyl chloride.

The hard surface layer 11 remains unbroken throughout the entire fabric as it extends over the vertically raised feature 12 and depressed feature 13. This ensures that the electrical current pathways do not bypass the hard surface layer 11 and therefore have to transverse over a longer path via the vertically raised feature 12 and depressed feature 13.

It is important to note that although similar vertically raised features 12 may be made via gluing, sewing or heat sealing of additional layers, the hard surface layer 11 is broken at the interface. This does not provide the same level of electrical protection because the electrical pathway 2 can bypass the vertical features by going underneath it. Similarly, vertically depressed features 13 may be made via cutting or removal of material. But the hard surface layer 11 is broken at the interface where the electrical path can access the human skin. Therefore, the use of cutting, gluing, sewing, heat sealing to form the vertically raised feature 12 or depressed feature 13 will negate the electrical protection benefits. The hard surface layer 11 must remain unbroken throughout the surface of the fabric 1.

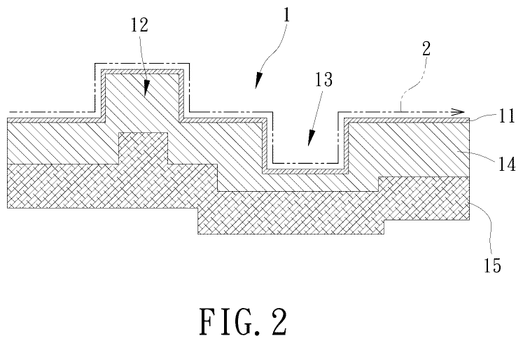

As shown in FIG. 2, the electrical pathway 2 length is significantly lengthened by the presence of the vertically raised feature 12 and depressed feature 13. The working principle is as follows: Since the electrical conductance is given by electrical conductivity multiplied by the length of the electrical pathway 2, an increase in the length of the electrical pathway 2 will result in the increase of the electrical conductance. A higher electrical conductance furthermore results in the reduction of electrical current for a given applied electrical voltage. Therefore, improved electrocution protection can be achieved by the increase in the length of electrical pathway 2 and hence the reduction of electrical conductance. In this invention, the length of surface electrical pathway 2 is increased by using tall vertically raised feature 12 and deep depressed feature 13 on the surface of the fabric 1.

In this invention, these vertically raised feature 12 and depressed feature 13 can be fabricated either by forming directly onto the fabric 1 via embossing or other equivalent techniques or cast in-situ during the manufacturing of the fabric 1. The tall vertically raised features 12 are at least 0.5 mm in height, spaced at least 0.5 mm apart, formed from the bulk layers. Similarly, the deep vertically depressed features 13 are at least 0.5 mm in depth, spaced at least 0.5 mm apart, formed from the bulk layers. Depending on the height of the vertically raised feature 12 or depth of the vertically depressed feature 13, the radius of curvature 17 can vary from 0.1 to 0.5 mm.

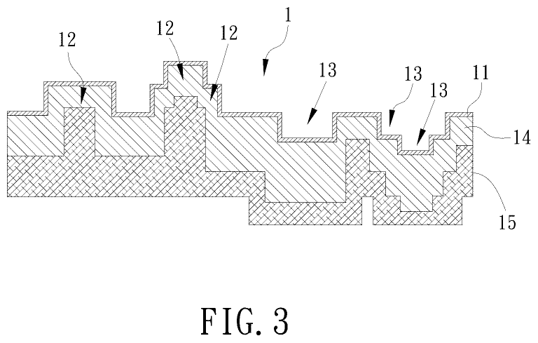

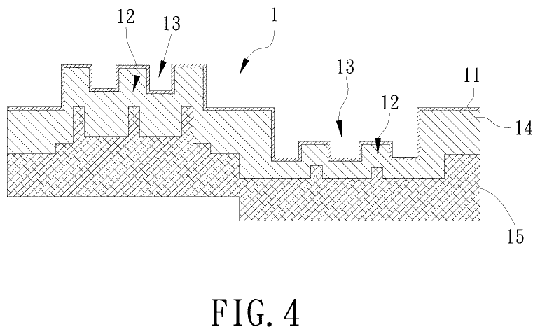

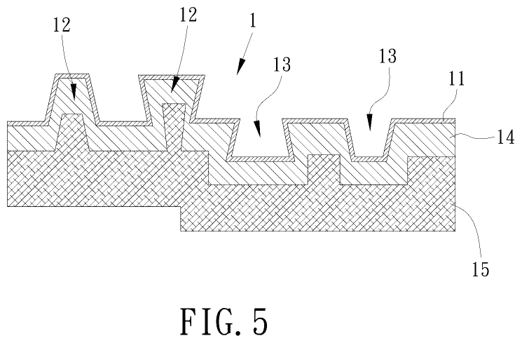

As shown in FIG. 3, the electrical pathway 2 can be further extended by having a vertically raised feature 12 within another vertically raised feature 12. Similar, the electrical pathway 2 can also be further extended by a vertically depressed feature 13 within another vertically depressed feature 13. Alternatively, as shown in FIG. 4, the electrical pathway 2 can be further extended by having a vertically raised feature 12 within a vertically depressed feature 13 or having a vertically depressed feature 13 within a vertically raised feature 12. As shown in FIG. 5, the taper angle of the sidewall 16 to the horizontal surface can vary from 30 to 150 degrees. This allows for modification of the electrical pathway 2 in each vertically raised feature 12 or depressed feature 13.

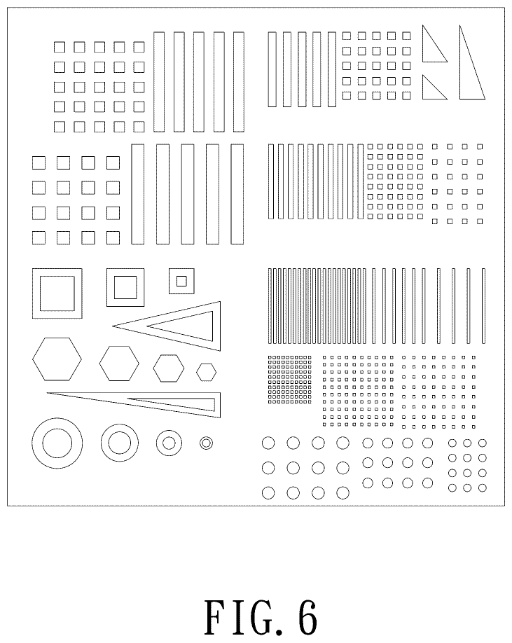

By using a combination of patterns as shown in FIG. 6, where the patterns can have different shapes and sizes such as circle, ellipse, polygon, square, rectangle, triangle, star, and free forms, the electrical pathway can be lengthened by at least 5% as compared to the surface length.

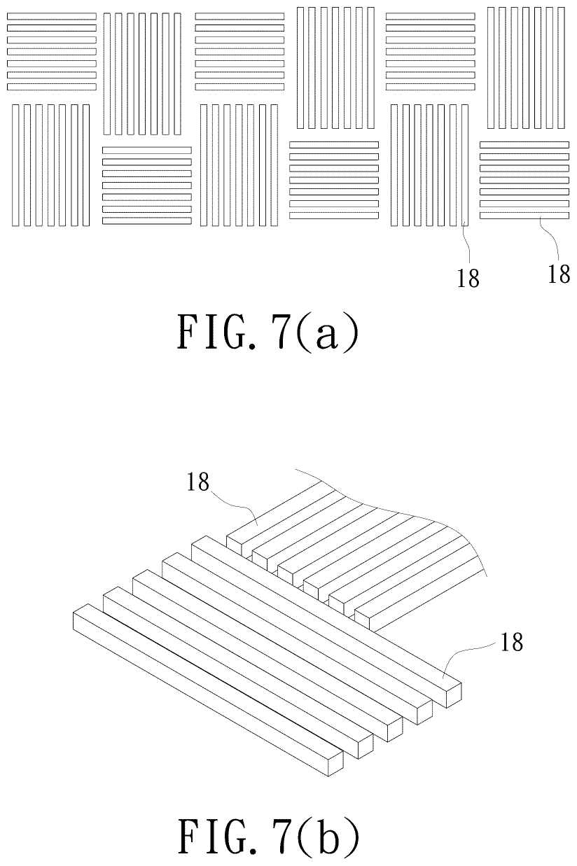

In embodiment 1 as shown in FIG. 7(a) and 7(b), the electrical pathway 2 is lengthened using a pattern of the vertical ridges 18 and trenches. There is no direct electrical pathway 2 from one end of the pattern to the other that has the same length as the surface length. The trench pattern is arranged such that there is no straight through path along which the electrical current can travel on the surface.

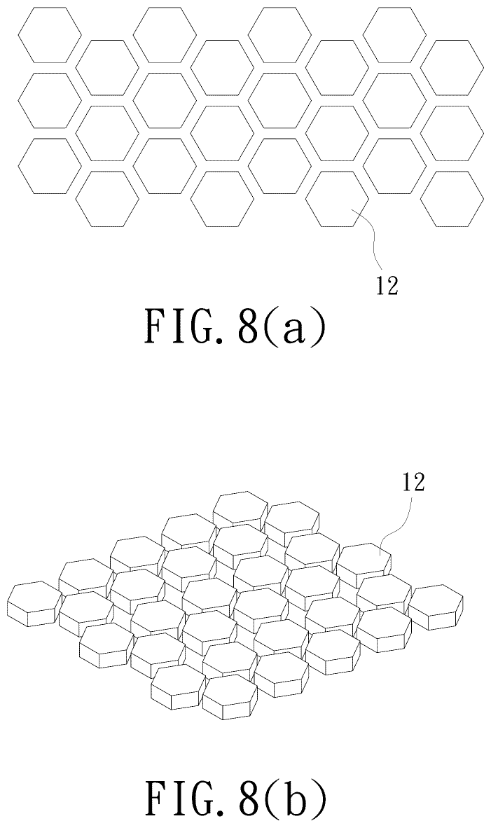

In embodiment 2, as shown in FIG. 8(a) and 8(b), the electrical pathway can also be lengthened by arranging hexagonal vertically raised feature 12 or depressed feature 13 (or combination of both) such that the there is again no straight path along which the electrical current can travel. Therefore, we can employ a combination of patterns shown in (but not limited to) FIG. 6 to create the desired electrical pathway 2 length on the surface of the fabric 1.

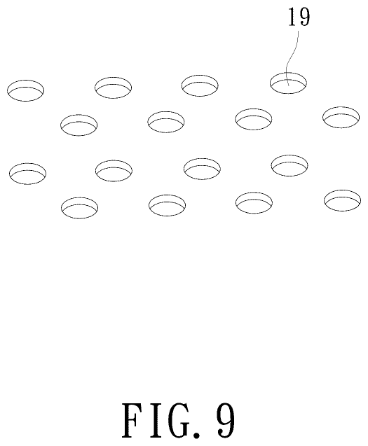

In embodiment 3, as shown in FIG. 9, the electrical pathway 2 can also be lengthened by an array of circular depressions 19 arranged such that there is again no straight path along which the electrical current can travel along the surface. Note that the radius of each circular depression 19 may vary to further convolute the electrical current path.

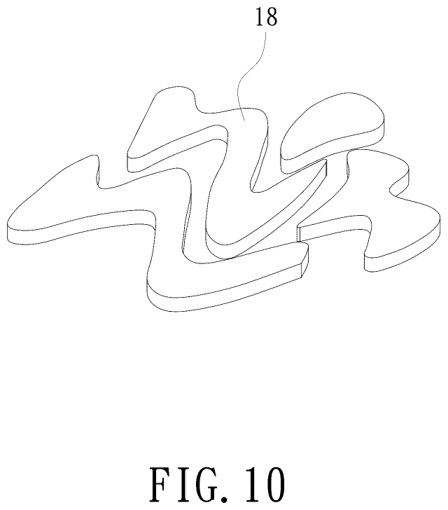

In embodiment 4, as shown in FIG. 10, the electrical pathway 2 can also be lengthened by a formation of a freeform ridges 18 and trenches such as there is again no straight path along which the electrical current can travel along the surface.

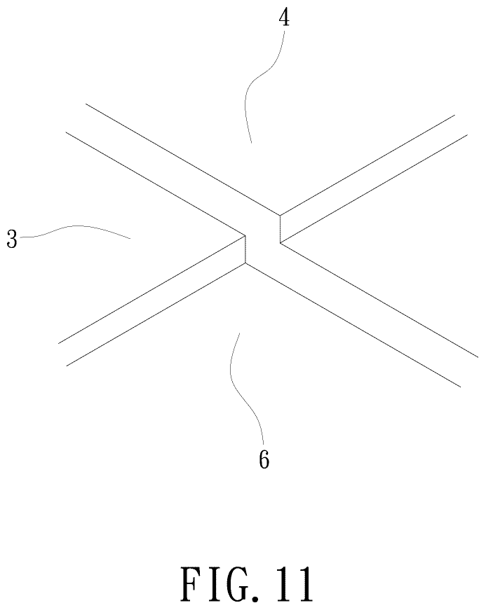

In embodiment 5, as shown in FIG. 11, the electrical path length on the surface can also be lengthened by using a series of cascading vertical features. Upon a base layer 6, the 1^{st} vertical feature 3 can be formed. Upon the 1^{st} vertical feature 3, a 2^{nd} vertical feature 4 can be formed and it can continue along the 1^{st} vertical feature 3 until it drops off to the base layer 6.

In combination of the variety of geometrical and freeform shapes, the cascading of vertical features allows the further convolution and hence lengthening of the electrical current path on the surface.

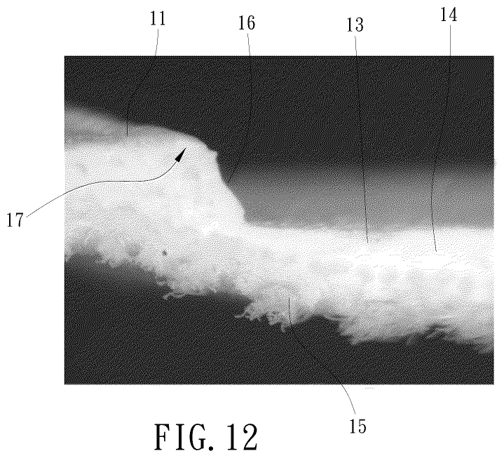

FIG. 12 shows the stereoscope cross-sectional photo of a vertically depressed feature 13 and its sidewall 16. The taper angle of the sidewall 16 is about 100 degrees from the horizontal surface. The foam bulk layer 14 is slight compacted from the manufacturing process while the hard surface layer 11 remains intact and unbroken. The radii of curvature at the outer and inner edges have a maximum upper limit that corresponds to the height of the vertically raised feature 12 or the depth of the vertically depressed feature 13.

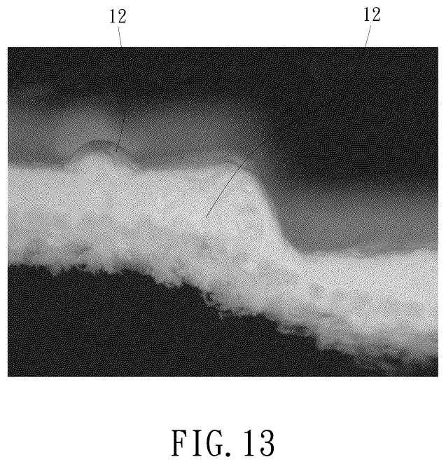

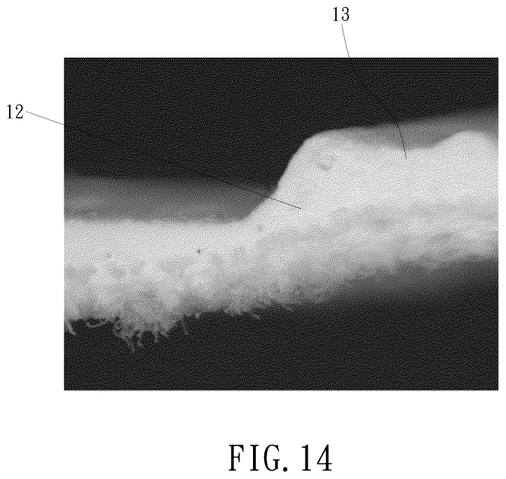

FIG. 13 shows the stereoscope cross-sectional photo of a vertically raised feature 12 within another vertically raised feature 12. The presence of the second vertically raised feature 12 further increase the electrical pathway 2. FIG. 14 shows the stereoscope cross-sectional photo of a vertically depressed feature 13 within another vertically raised feature 12. The presence of the second vertically depressed feature 12 further increases the electrical pathway 2 on the surface. The vertically raised feature 12 and depressed feature 13 forming at least 10% of the total surface area.

It is very important to emphasize that the hard surface layer 11 must remain continuous and unbroken. The foam bulk layer 14 and fiber bulk layer 15 cannot be exposed at any point on the surface. Otherwise it will shorten the electrical current path length and increases the risk of electrocution.

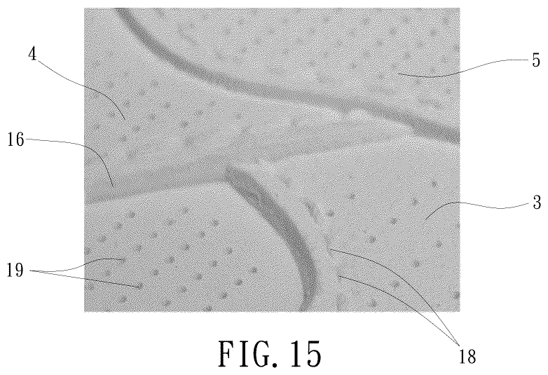

FIG. 15 shows the photograph of a preferred embodiment that depicts a base layer 6 with an array of circular depressions 19, and a cascade of vertical features as follows: a 1^{st} vertical layer 3 with vertically ridges 18 and an array of circular depressions 19; a 2^{nd} vertical layer 4 with vertical ridges 18 and an array of circular depressions 19; a 3^{rd} vertical layer 5 with vertical ridges 18 and an array of circular depressions 19. The height of the sidewall 16 of each vertical feature is more than 0.5 mm. The shape of the 1^{st} vertical feature is linear with straight sidewall 16. The shape of the 2^{nd} and 3^{rd} vertical features are free form with curvy sidewalls 16. The circular depressions 19 do not interrupt the hard surface layer 11 continuity.

What is claimed:

1. A flexible electrical insulating fabric consisting of:
(i) A plurality of surface electrical pathways with lengths longer than the length of the surface;
(ii) A hard surface layer of compressed elastomer at the top varying surface roughness from 10 nm to 0.1 mm with electrical conductivity of at least 1×10⁻¹² S/m;
(iii) A soft foam bulk layer of air and elastomer matrix of at least 0.5 mm thick and electrical conductivity of at least 1×10⁻¹² S/m;
(iv) A soft fiber bulk layer of air and elastomer matrix of at least 0.5 mm thick and electrical conductivity of at least 1×10⁻¹² S/m;
(v) A plurality of vertically raised features of at least 0.5 mm in height, spaced at least 0.5 mm apart, formed from compacting the bulk layers;
(vi) A plurality of vertically depressed features of at least 0.5 mm in depth, spaced at least 0.5 mm apart, deformed into the bulk layers;
(vii) The vertically raised and depressed features forming at least 10% of the total surface area;
(viii) The hard surface layer covers the entire surface with no exposure of the bulk foam layer and bulk fiber layer.

2. The vertically raised features of claim 1 having at least one edge.

3. The vertically depressed features of claim 1 having at least one edge.

4. The vertically raised and depressed features of claim 1 have a taper angle range of 30 to 150 degrees from the horizontal.

5. The vertically raised features of claim 2 may have vertically depressed features within it.

6. The vertically depressed features of claim 3 may have vertically raised features within it.

7. The edge radius of curvature of the vertically raised features of claim 2 has an upper limit that corresponds to the height of the vertical raised features.

8. The edge radius of curvature of the vertically depressed features of claim 3 has an upper limit that corresponds to the depth of the vertically depressed features.

9. The surface electrical pathway of claim 1 is at least 5% longer than that of the surface length over a given surface area.

10. The vertically raised and depressed features of claim 1 have shapes of but not limited to circle, ellipse, polygon, square, rectangle, triangle, star, and free forms.

11. The elastomer of claim 1 can be but not limited to thermoplastic elastomers, thermoplastic polyurethane, thermoplastic polyester elastomer, ethylene vinyl-acetate, polyester, and polyvinyl chloride.

12. The air and elastomer matrix of claim 1 consists of at least 10 % elastomer by volume.
